(19) United States
(12) Patent Application Publication
(10) Pub. No.: US 2021/0349300 A1
(43) Pub. Date: Nov. 11, 2021

(54) FIXED MAGNIFICATION OPTICAL AIMING DEVICE FOR A FIREARM

(71) Applicant: PRIMARY ARMS, LLC, HOUSTON, TX (US)

(72) Inventors: ROBERT E SHEETS, JR., HOUSTON, TX (US); MARSHALL LERNER, HOUSTON, TX (US)

(21) Appl. No.: 17/315,217

(22) Filed: May 7, 2021

Related U.S. Application Data
(60) Provisional application No. 63/022,314, filed on May 8, 2020.

(51) Int. Cl. G02B 23/10; F41G 1/38; F41G 1/34

(52) U.S. Cl. CPC G02B 23/10; F41G 1/345; F41G 1/38

(57) ABSTRACT

The present disclosure is directed to a fixed magnification optical aiming device for a firearm including one or more high efficiency illumination sources alone or in combination with one or more lenses and/or other light collection devices to increase reticle illumination efficiency. The optical aiming device may include one or more internal power supplies, one or more external power supplies, and one or more solar cells.

### CROSS-REFERENCE TO RELATED APPLICATIONS

This application claims benefit of U.S. Provisional Patent Application Ser. No. 63/022,314, filed on May 8, 2020, the content of which is hereby incorporated by reference in its entirety.

### STATEMENT REGARDING FEDERALLY SPONSORED RESEARCH OR DEVELOPMENT

Not applicable.

### BACKGROUND OF THE DISCLOSURE

### 1. Field of the Disclosure

The present disclosure is directed to an optical aiming device for firearms.

### 2. Background Art

One type of optical aiming device used with firearms includes a prism sight also referred to as a “prismatic sight,” which includes a glass prism operationally configured to focus an image in conjunction with one or more lenses, e.g., one or more lenses commonly found in traditional optical aiming devices such as telescopic sights. Prism sights include a reticle etched on the glass prism and illumination systems for illuminating the reticle. Historically, illumination of reticles in prism sights has been accomplished via standard light emitting diodes or via fiber optic illumination. A downside to standard light emitting diodes is that they require a significant amount of power to provide a daylight visible reticle, i.e., illuminate a reticle during maximum brightness outdoors. As such, battery life is quite short to provide daylight visible reticle illumination. Solar cells have been employed in some optical sights to extend the battery life. However, the inclusion of a solar cell in known prism sights is not viable as the total needed charging current of known solar cells cannot keep up with demands of standard light emitting diodes.

Overcoming the above shortcomings is desired.

### SUMMARY OF THE DISCLOSURE

The present disclosure is directed to a fixed magnification optical aiming device for a firearm, comprising: (1) a prism system including a reticle, (2) one or more high efficiency illumination sources operationally configured to illuminate the reticle, (3) an MCU operationally configured to power the one or more high efficiency illumination sources, (4) one or more internal power supplies in electrical communication with the micro control unit, (5) one or more external power supplies in electrical communication with the micro control unit, (6) one or more solar cells in electrical communication with the micro control unit, and (7) a motion sensor in electrical communication with the micro control unit.

The present disclosure is also directed to a prism sight for a firearm, comprising (1) a MCU mounted to a PCB; (2) a wake-up system mounted to the PCB in electrical communication with the MCU, (3) one or more internal power supplies in electrical communication with the MCU; (4) one or more external power supplies in electrical communication with the MCU, (5) one or more solar cells in electrical communication with the MCU; and (6) one or more high efficiency LEDs in electrical communication with the MCU; wherein the MCU is programmed to (a) turn the prism sight to an OFF position if no motion of the prism sight is detected for a predetermined period of time and (b) turn the prism sight to an ON position when the wake-up system detects motion of the prism sight; and wherein the one or more internal power supplies and one or more external power supplies are operationally configured to power the prism sight for a period of about one month when the prism sight is set to an ON position at a maximum brightness and in constant motion.

The present disclosure is also directed to a fixed magnification optical aiming device for a firearm, comprising (1) a prism system including a reticle, (2) a primary internal power supply, (3) a secondary power supply operationally configured to recharge the primary power supply, and (4) a tertiary power supply comprising solar energy harvesting technology operationally configured to power the fixed magnification optical aiming device and charge the primary internal power supply.

### BRIEF DESCRIPTION OF THE SEVERAL VIEWS OF THE DRAWING

FIG. 1 is a cross-sectional side view of an embodiment of a fixed magnification optical aiming device of the present disclosure.

FIG. 2 is a cross-sectional side view of an embodiment of a fixed magnification optical aiming device of the present disclosure.

FIG. 3 is a perspective view of an embodiment of a fixed magnification optical aiming device of the present disclosure.

FIG. 4 is a schematic view of an embodiment of a printed circuit board of a fixed magnification optical aiming device of the present disclosure.

### DEFINITIONS USED IN THE DISCLOSURE

The term “at least one”, “one or more”, and “one or a plurality” mean one thing or more than one thing with no limit on the exact number; these three terms may be used interchangeably within this disclosure. For example, at least one device means one or more devices or one device and a plurality of devices.

The term “about” means that a value of a given quantity is within ±20% of the stated value. In other embodiments, the value is within ±15% of the stated value. In other embodiments, the value is within ±10% of the stated value. In other embodiments, the value is within ±7.5% of the stated value. In other embodiments, the value is within ±5% of the stated value. In other embodiments, the value is within ±2.5% of the stated value. In other embodiments, the value is within ±1% of the stated value.

The term “substantially” or “essentially” means that a value of a given quantity is within ±10% of the stated value. In other embodiments, the value is within ±7.5% of the stated value. In other embodiments, the value is within ±5% of the stated value. In other embodiments, the value is within ±2.5% of the stated value. In other embodiments, the value is within ±1% of the stated value. In other embodiments, the value is within ±0.5% of the stated value. In other embodiments, the value is within ±0.1% of the stated value.

### DETAILED DESCRIPTION OF THE DISCLOSURE

For the purposes of promoting an understanding of the principles of the disclosure, reference is now made to the embodiments illustrated in the drawings and particular language will be used to describe the same. It is understood that no limitation of the scope of the claimed subject matter is intended by way of the disclosure. As understood by one skilled in the art to which the present disclosure relates, various changes and modifications of the principles as described and illustrated are herein contemplated.

It is to be understood that the present disclosure is not limited to particular embodiments. It is also to be understood that the terminology used in this disclosure is for the purpose of describing particular embodiments only, and is not intended to be limiting. For purposes of this disclosure, a standard light emitting diode (or “standard LED”) refers to a light emitting diode having a luminous efficacy up to or about 140.0 lm/W (lumens per watt) in the visible spectrum from or about 590.0 nanometers to or about 660.0 nanometers. The term “high efficiency light emitting diode” (or “high efficiency LED”) refers to a light emitting diode having a luminous efficacy greater than 140.0 lm/W in the visible spectrum from or about 590.0 nanometers to or about 660.0 nanometers. One non-limiting example of a high efficiency LED includes a resonant cavity light emitting diode (hereafter “RCLED”). As understood by the skilled artisan, a RCLED is a light emitting diode in which the active region of the diode is placed in a resonant optical cavity. One suitable RCLED for purposes of this disclosure includes a 3.5×2.2 SMD Flat Lens (2 pin); part number MTPS9062MC-BK, commercially available from Marktech Optoelectronics, Inc., Latham, N.Y., U.S.A.

Herein, the phrase “high efficiency illumination” may be used interchangeably with the phrase “energy efficient illumination.” Regarding an optical aiming device of this disclosure, the phrase “functionally infinite illumination power” refers to one or more power supplies of the optical aiming device being operationally configured to maintain power over time effective to illuminate a reticle of the optical aiming device as and when desired according to the rechargeability of one or more internal power supplies via one or more external power supplies of the optical aiming device including one or more external batteries and one or more external solar cells. The phrases “near infinite operating power,” and “near infinite illumination power” may be used interchangeably with the phrase “functionally infinite illumination power.” Regarding an optical aiming device of this disclosure, the term “maximum brightness” refers to the highest brightness setting of the optical aiming device effective to produce a desired brightness of the illumination source. For example, if an optical aiming device comprises six brightness settings, e.g., settings one through six (1-6), the maximum brightness of the illumination source is achieved at setting six.

In one embodiment, the present disclosure is directed to an optical aiming device for firearms including a prism system, one or more high efficiency illumination sources alone or in combination with one or more lenses and/or other light collection devices operationally configured to increase reticle illumination efficiency of the optical aiming device, i.e., using less current to focus light onto a reticle of the optical aiming device effective to realize a desired reticle brightness level. The optical aiming device may also comprise one or more one or more photovoltaic cells or solar cells effective for powering one or more high efficiency illumination sources of the optical aiming device.

In another embodiment, the present disclosure is directed to an optical aiming device for firearms comprising a prism system, one or more high efficiency illumination sources, one or more photovoltaic cells or solar cells and a programmed automatic OFF/ON feature comprising a mechanical motion sensor. The optical aiming device further comprises a microcontroller or micro control unit (“MCU”) programmed to direct the optical aiming device to an OFF position once the optical aiming device becomes motionless for a predetermined period of time, i.e., when the optical aiming device realizes full motionless. The MCU is also operationally configured to direct the optical aiming device to an ON position once the mechanical motion sensor senses motion of the optical aiming device.

In another embodiment, the present disclosure is directed to an optical aiming device comprising a prism system, a primary power supply, and a secondary power supply operationally configured to recharge the primary power supply. In one embodiment, the primary power supply may comprise an internal power supply such as one or more internal batteries and the secondary power supply may comprise one or more removable external batteries. The optical aiming device may also comprise a tertiary power supply comprising solar energy harvesting technology. Suitable solar energy harvesting technology may comprise one or more photovoltaic cells or solar cells. In one embodiment, the secondary power supply and the tertiary power supply may be described as backup power sources of the optical aiming device wherein the secondary power supply and/or the tertiary power supply are operationally configured to set the optical aiming device to an ON position in the event the internal power supply is completely drained of power.

In another embodiment, the present disclosure is directed to an optical aiming device operationally configured to maintain operable power for a plurality of scenarios in which the optical aiming device may otherwise run out of power. In one embodiment, an optical aiming device of this disclosure may comprise one or more internal batteries and one or more external batteries operationally configured to (1) power the optical aiming device for a period of about one month when the optical aiming device is set to an ON position at maximum brightness or highest brightness and when the optical aiming device is in constant motion, and (2) power the optical aiming device for a period of about twelve months when the optical aiming device is set to an ON position at medium brightness and when the optical aiming device is in constant motion according to the capacity of the one or more external batteries. Because such scenarios are unlikely to be realized in actual operations, the one or more internal batteries and one or more external batteries are operationally configured to provide an optical aiming device with continuous operating power. The optical aiming device may also comprise solar energy harvesting technology whereby in an unlikely event that the one or more internal batteries and/or the one or more external batteries are completely drained of power or where the power available is too low to operate the optical aiming device as desired, a user may replace either the one or more external batteries or expose the optical aiming device to artificial light and/or sunlight to enable use of the solar energy harvesting technology of the optical aiming device to power the optical aiming device.

In another embodiment, the present disclosure is directed to a fixed magnification optical aiming device for a firearm, comprising (1) a prism system, (2) an illuminated reticle, (3) one or more high efficiency illumination sources, (4) a micro control unit operationally configured to power the one or more high efficiency illumination sources, (5) one or more internal power supplies in electrical communication with the micro control unit, (6) one or more solar cells in electrical communication with the micro control unit, (7) a motion sensor in electrical communication with the micro control unit and (8) one or more external power supplies in electrical communication with the micro control unit.

In another embodiment, the present disclosure is directed to a fixed magnification optical aiming device for a firearm operationally configured to provide functionally infinite illumination power of the optical aiming device, the device including one or more internal power supplies and one or more external power supplies, wherein the user is only required to change out the one or more external power supplies in accordance with the commercial shelf life of the one or more external power supplies.

In another embodiment, the present disclosure is directed to a fixed magnification optical aiming device for a firearm having a more stream lined ornamental appearance compared to rotary dial and coin cell battery powered optical aiming devices of the prior art.

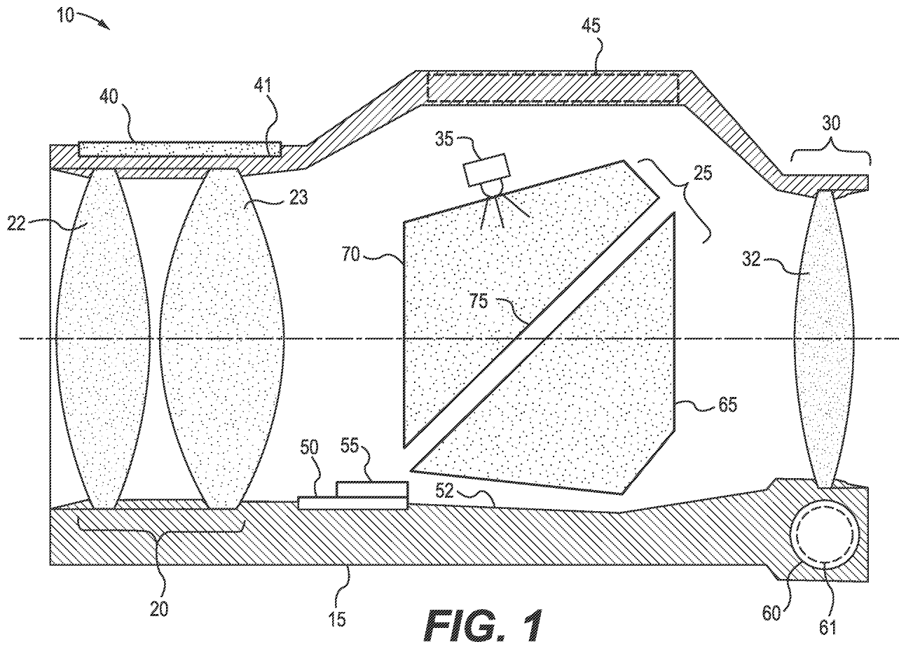

With reference to FIG. 1, in a first embodiment a fixed magnification optical aiming device 10 (hereafter “aiming device 10”) is provided, the aiming device 10 including an outer housing 15, an objective lens system 20 disposed within the housing 15 at or near a first end of the aiming device 10, an ocular lens system 30 disposed within the housing 15 at or near a second end of the aiming device 10, an image erector system including a prism assembly 25 (or “Pechan prism assembly 25”) disposed within the housing 15 between the objective lens system 20 and the ocular lens system 30, one or more high efficiency illumination sources 35 (hereafter “illumination source 35”), one or more photovoltaic cells or solar cells 40, an elevation adjustment turret 45, control circuitry comprising circuitry formed on a printed circuit board (“PCB 50”), a primary power supply 55 (or “internal power supply 55”) and a power supply storage compartment 60 for holding at least one external secondary power supply 61 (or “external power supply 61”). For purposes of this disclosure, the aiming device 10 may also be referred to as “prism sight 10.”

Still referring to FIG. 1, the prism assembly 25 includes a glass roof prism 65, a glass mirror prism 70 and a reticle 75 etched into the face of the mirror prism 70. A reticle 75 of this disclosure may include one or more indicia in one or more layouts or configurations as desired. Exemplary reticles operable as a reticle 75 of the present prism sight 10 include, but are not necessarily limited to reticles as provided in U.S. Pat. No. D700,944, titled “Reticle System,” issued on Mar. 11, 2014; U.S. Pat. No. D767,660, titled “Reticle System,” issued on Sep. 27, 2016; U.S. Pat. No. D716,409, titled “Reticle System,” issued on Oct. 28, 2014, each of which is herein incorporated by reference in its entirety.

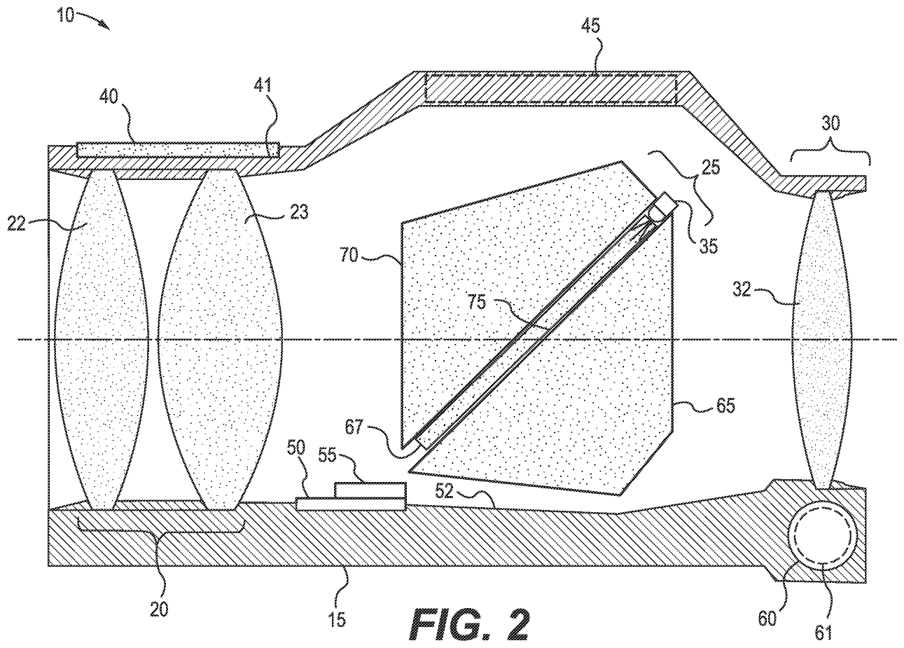

As shown in FIG. 1, the illumination source 35 is located adjacent the mirror prism 70 facing the mirror prism 70 in a manner effective to illuminate the reticle 75. In one suitable embodiment, the reticle 75 may be etched into the face of the mirror prism 70 in a manner effective for the illumination source 35 to illuminate the entire reticle 75. As shown in FIG. 2, in another embodiment a prism assembly 25 may include an intermediate lens 67 disposed between the glass roof prism 65 and the mirror prism 70 including a reticle 75 etched into the face of the intermediate lens 67. In the embodiment of FIG. 2, the illumination source 35 is located between the glass roof prism 65 and the glass mirror prism 70 in a manner effective to illuminate the reticle 75.

In the embodiments of FIGS. 1 and 2, the objective lens system 20 comprises an eyepiece lens 22 and a double-convex lens 23 and the ocular lens system 30 comprises a double-convex lens 32. In another embodiment of the prism sight 10, the objective lens system 20 may comprise a single convex-plano doublet lens and/or one or more other lenses known in the art of optical aiming devices in combination with an eyepiece lens 22 and/or a double-convex lens 23 and the ocular lens system 30 may comprise a convex-concave doublet lens.

One suitable illumination source 35 may comprise one or more high efficiency LEDs such as one or more RCLEDs operationally configured to illuminate a reticle 75 of the prism sight 10 to a desired brightness level. Without limiting the disclosure, one suitable high efficiency LED may include a red/green high efficiency LED operationally configured for selectable red/green illumination of a reticle 75 at a plurality of intensity levels, e.g., two to fifteen intensity levels. As shown in the embodiment of FIG. 1, the illumination source 35 may be secured to the mirror prism 70 of the prism assembly 25, i.e., secured to the lens comprising the reticle 75. In one embodiment, the illumination source 35 may be secured to the mirror prism 70 via mechanical connection including, but not necessarily limited to one or more fasteners, one or more retainers, one or more adhesives, and combinations thereof. As shown in the embodiment of FIG. 2, the illumination source 35 may be secured to the intermediate lens 67 and/or the glass roof prism 65 and/or the mirror prism 70. In another embodiment, one or more focusing lenses and/or other light collection device(s), e.g., one or more prism elements, may be employed as part of the prism sight 10 operationally configured to intensify the focusing of light onto the reticle 75 thereby achieving a desired brightness level and reducing the amount of current required to illuminate the reticle 75 to the desired brightness level making the illumination of the reticle 75 more efficient. Without limiting the disclosure, one or more focusing lenses may be disposed between the illumination source 35 and the lens comprising the reticle 75.

With further reference to FIG. 1, a suitable PCB 50 of the prism sight 10 may include a patterned arrangement of printed circuitry and components mounted to the surface of the PCB 50 for operation of the prism sight 10. In one embodiment, the PCB 50 may be attached directly to the inner surface 52 of the housing 15 via fasteners, adhesive, or combinations thereof. In another embodiment, the PCB 50 may be attached to a support surface such as a support plate or support frame that is secured to the inner surface 52 of the housing 15. In another embodiment, the PCB 50 may be attached directly adjacent one or more solar cells 40 described below.

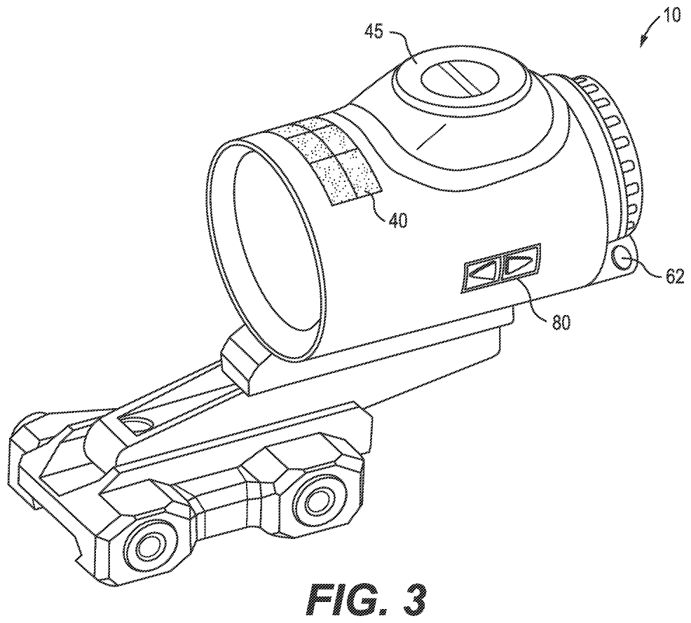

In one embodiment, a primary power supply 55 may include one or more super capacitors and/or one or more internal lithium ion rechargeable batteries in electrical communication with the PCB 50 as shown in FIG. 1. For purposes of the present disclosure, the internal storage capacity and charging rate of the primary power supply 55 may be relatively low, e.g., capacity of 50.0 Amp-hours, to provide a prism sight 10 characterized by functionally infinite illumination power (e.g., up to or about 48.0 hours at maximum brightness). As further depicted in FIG. 1, the power supply storage compartment 60 for an external secondary power supply 61 may be provided as a nonobtrusive storage compartment in a size and shape operationally configured to receive one or more particular size and shape power supplies 61 therein, e.g., one or more particular removable batteries. One suitable external secondary power supply 61 may comprise a capacity ranging from 120.0 mAh to 180.0 mAh. One non-limiting example of a battery usable as a secondary power supply 61 may include a ⅓N Lithium battery with a capacity of 160.0 mAh Similar as external battery storage compartments of other known electronic devices, the power supply storage compartment 60 may include an adjustable cover member 62 (see FIG. 3) operationally configured to maintain one or more removable batteries within the power supply storage compartment 60 during operation of the prism sight 10.

As shown in FIG. 3, in one embodiment the outer surface of the housing 15 is operationally configured as a support surface for one or more photovoltaic cells or solar cells 40 (hereafter “one or more solar cells 40”), which are operationally configured to convert light energy into electrical energy for providing power or charging a primary power supply 55 and also for powering electrical components including, but not necessarily limited to the illumination sources 35 and/or other components of the prism sight 10.

Suitably, the one or more solar cells 40 of this disclosure are operationally configured to utilize ambient light, both natural and artificial ambient light. The one or more solar cells 40 may include, but are not necessarily limited to one or more thin-film and/or flexible thin-film photovoltaic solar cells, including, but not necessarily limited to monocrystalline thin-film solar cells, cadmium telluride thin-film solar cells, copper indium gallium selenide (“CIGS”) thin-film solar cells, gallium arsenide thin-film solar cells, amorphous silicon thin-film solar cells, and combinations thereof. The one or more solar cells 40 may also include one or more wafer-based solar cells such as crystalline silicon photovoltaics, e.g., monocrystalline silicon, polycrystalline silicon. In addition, the one or more solar cells 40 are operationally configured to produce a voltage or charging voltage effective for powering the illumination source 35 of the prism sight 10. Without limiting the disclosure, any charging voltage may be employed whereby the output voltage may be regulated by way of the PCB 50. Suitably, the current output of the illumination source 35 is independent the one or more solar cells 40. In addition, the size and thickness of the one or more solar cells 40 employed may vary but may be provided in a number and size/thickness as few and as small as possible to meet the operating demands of the prism sight 10. Without limiting the disclosure, a suitable thickness of the one or more solar cells 40 may range from or about 0.2 mm to or about 2.0 mm. For purposes of this disclosure, the one or more solar cells 40 may include an operating temperature range from or about −40.0° C. to or about 80.0° C.

One exemplary solar cell 40 for use with the prism sight 10 may include a flexible thin-film CIGS solar cell commercially available from PowerFilm Solar Inc., located in Ames, Iowa, U.S.A. In one suitable embodiment, the prism sight 10 may include a number of solar cells 40 effective for continual illumination of the prism sight 10. For example, a suitable number of flexible thin-film CIGS solar cells 40 for operation of a prism sight 10 as shown in FIGS. 1-3 may range from one to ten (1.0 to 10.0) solar cells 40, wherein the one or more solar cells 40 are mounted to one or more recessed surfaces 41 via optically clear epoxy, mechanically via screws, retaining rings, and combinations thereof.

With reference to FIG. 3, the outer surface of the housing 15 may also comprise one or more external tactile switches 80 for manual illumination control of the prism sight 10 and/or for setting the prism sight 10 to a true OFF position. In one suitable embodiment, external tactile switches 80 may include low profile push buttons as shown in FIG. 3, e.g., low profile rubber push buttons. In another embodiment, the prism sight 10 may include an illumination knob for manual illumination control of the prism sight 10 and/or for setting the prism sight 10 to a true OFF position.

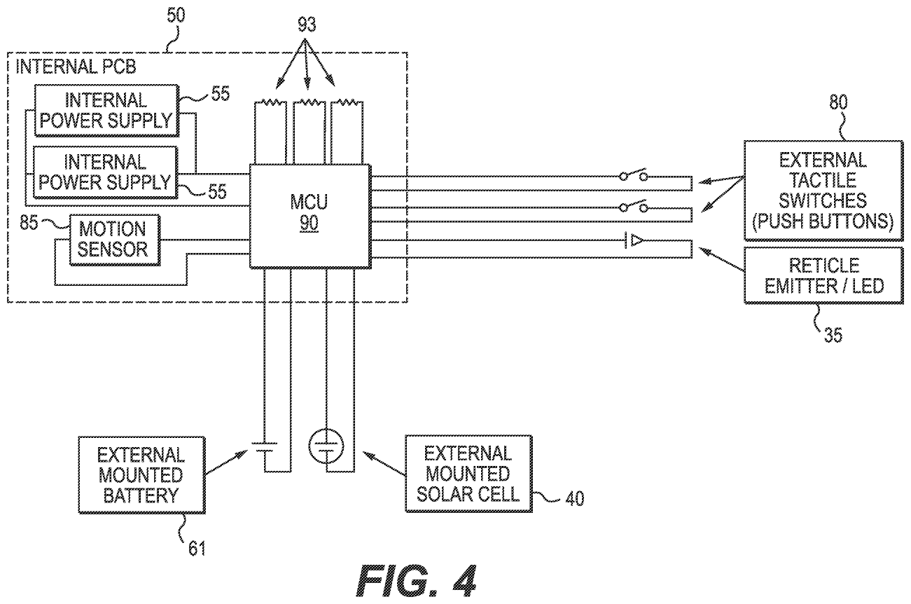

Turning to FIG. 4, in one embodiment a PCB 50 comprises an internal primary power supply 55 and an MCU 90 in electrical communication with the (1) internal primary power supply 55, (2) an external secondary power supply 61, (3) one or more solar cells 40 and (4) the illumination source 35 as shown whereby the MCU 90 is operationally configured to control or regulate the output power, the output voltage, the rate of electric current, the charging current voltage and charging current rate of the prism sight 10. As shown, the prism sight 10 may further include a wake-up system including a piezoelectric accelerometer or a mechanical motion sensor 85 mounted to the PCB 50, whereby the MCU 90 is programmed to turn the prism sight 10 to an OFF position automatically if no motion or movement of the prism sight 10 is detected for a particular period of time and turn the prism sight 10 to an ON position automatically when the accelerometer or mechanical motion sensor 85 detects motion or movement of the prism sight 10. Such feature may be referred to herein as an automatic ON/OFF time out feature of the prism sight 10.

In one embodiment, the electrical circuit for each of the one or more solar cells 40 may include an analog circuit. In another embodiment, the electrical circuit for each of the one or more solar cells 40 may include a digital circuit. The PCB 50 may also include a voltage regulator circuit, one or more resistors (see resistor array 93), one or more capacitors, one or more relays, and other electrical components as may be required for a particular operation.

Historically, illumination of an optical aiming device comprising a Pechan prism assembly is accomplished via standard LEDs and/or fiber optic illumination as described in U.S. Pat. No. 8,364,002 B2, titled “Optical Sight,” issued on Jan. 29, 2013, and U.S. Pat. No. 8,009,958 B1, titled “Optical Sight,” issued on Aug. 30, 2011, each of which is herein incorporated by reference in its entirety. One drawback of using standard LEDs, i.e., non-high efficiency light emitting diodes, is that standard LEDs required a large amount of power for proper illumination of a reticle. Even where one or more solar cells may be used with standard LEDs, the one or more solar cells do not provide enough power to adequately recharge a primary power source, i.e., the internal storage, to meet the power demands of standard LEDs. As such, a primary power source of a prior art optical aiming devices is prone to being drained of power over time rendering the optical aiming device operably dead unable to illuminate its reticle. For such a reason, the prism sight 10 of the present disclosure combines an internal primary power supply 55, an external secondary power supply 61 and one or more solar cells 40 to collectively provide continuous power to the prism sight 10 whereby the prism sight 10 maintains its ability to illuminate the reticle 75. In addition, by using high efficiency illumination via illumination source 35, the size and number of one or more solar cells 40 may be minimized and still operate to provide continuous power of the prism sight 10.

In one embodiment, a prism sight 10 comprises a combination of an internal primary power supply 55, an external secondary power supply 61 and one or more solar cells 40 that operate collectively with an automatic ON/OFF time out feature of the MCU 90 to prevent or otherwise reduce the chance for power drainage of the prism sight 10 over the operating life of the prism sight 10. For example, in a scenario where an individual accidently stores away the prism sight 10 in an ON position, without use of the one or more solar cells 40 the internal primary power supply 55 may be completely drained of power over time, i.e., drained dead. However, by programming the MCU 90 to turn the prism sight 10 to an OFF position automatically when no motion or movement of the prism sight 10 is detected over a predetermined period of time, complete power drainage of the internal primary power supply 55 is prevented. In addition, the automatic ON/OFF time out feature of the prism sight 10 is operationally configured to detect motion or movement and once motion or movement of the prism sight 10 is detected the MCU 90 is programmed to turn the prism sight 10 to an ON position.

Although, the MCU 90 is programmed to set the prism sight 10 to an OFF position as described above, such a setting is not a true OFF position of the MCU 90 because the MCU 90 still requires power from the internal primary power supply 55 in order for the MCU 90 to remain in an ON position under just enough power effective for the MCU 90 to receive a signal from the motion sensor 85 to direct the prism sight 10 to an ON position. Accordingly, given enough time in an OFF position the MCU 90 may completely drain the internal primary power supply 55 resulting in the prism sight 10 being in a true OFF position. For example, it may take one to two months for the prism sight 10 to reach a true OFF position when using the one or more super capacitors and/or one or more internal lithium ion rechargeable batteries described above as the internal primary power supply 55. In one embodiment, the external secondary power supply 61 may be operationally configured to prevent complete drainage of the prism sight 10, as a MCU 90 of the present disclosure is suitably operationally configured to draw as little as 9.0 nanoamps from the external secondary power supply 61 allowing the prism sight 10 to operate in an OFF position (or “sleep mode”) for more than one year, i.e., more than 365 days. In a scenario where the power supply storage compartment 60 is empty or where an external secondary power supply 61 located in the power supply storage compartment 60 is dead, a new or operable external secondary power supply 61 may be placed within the power supply storage compartment 60 to power the prism sight 10 to an ON position, whereby the prism sight 10 may operate via power supplied from the external secondary power supply 61 until the internal primary power supply 55 is fully or at least partially recharged by the one or more solar cells 40.

In another scenario where an individual accidently stores away the prism sight 10 in an ON position and the prism sight 10 is subject to constant motion, e.g., where the prism sight 10 is located in a trunk of a vehicle with no ambient light available, the one or more solar cells 40 are not able to meet the energy demands of the illumination source 35 set to an ON position. As such, the external secondary power supply 61 of the prism sight 10 is operationally configured to supply power to operate the illumination source 35. Likewise, in a scenario where the internal primary power supply 55 is dead and the prism sight 10 requires illumination of the reticle 75 but the prism sight 10 is under dark or low light conditions unable to make use of the one or more solar cells 40, the external secondary power supply 61 of the prism sight 10 is operationally configured to power the illumination source 35 as an external secondary power supply 61 of this disclosure is operationally configured to power the illumination source 35 in excess of 20,000.00 hours at a medium brightness setting of the illumination source 35.

Accordingly, the prism sight 10 may also be referred to as an optical sight system operationally configured to essentially cover all scenarios in which an optical aiming device of the prior art may run out of power. As an example, in an unlikely event where the prism sight 10 is unintentionally set to an ON position at maximum brightness of the illumination source 35 and left in a location resulting in constant motion or movement of the prism sight 10, for example, left in a trunk of vehicle driven regularly for a period of time long enough to completely drain both the internal primary power supply 55 and the external second power supply 61—a period of about one month at a maximum brightness setting of the illumination source 35 and a period of about six months at a medium brightness setting of the illumination source 35—once the one or more solar cells 40 of the prism sight 10 are exposed to ambient light the one or more solar cells 40 are operationally configured to charge the primary power supply 55 in a manner effective for the illumination source 35 to illuminate the reticle 75. Or, if desired, the drained external second power supply 61 may be replaced by a charged external second power supply in order to power the illumination source 35.

The housing 15 of the prism sight 10 may be constructed from one or more metals, one or more plastics, one or more composite materials, and combinations thereof. One suitable metal includes stainless steel. Another suitable metal includes aluminum. Another suitable metal includes 6063 aluminum alloy. Another suitable metal includes 6061-T6 aluminum alloy. As understood by persons of ordinary skill in the art of optical aiming devices, a metal housing 15 may include a matte paint finish or a hardcoat anodized finish.

As understood by the skilled artisan, in one embodiment the prism sight 10 may comprise one or more O-ring seals disposed between the housing 15 and the objective lens system 20 and/or the ocular lens system 30 providing an air-tight seal operationally configured to prevent debris such as dust and dirt and fluid such as air and water from entering the housing 15. As also known by the skilled artisan, the prism sight 10 may also be nitrogen purged to prevent fogging inside the prism sight 10.

In one embodiment, the prism sight 10 may comprise one or more firearm mounts and one or more risers. Other features may also be employed as desired, for example, a prism sight 10 of this disclosure may include a threaded housing at the objective lens system 20 for receiving threaded anti-reflective devices and/or tool adjustable turrets.

The disclosure will be better understood with reference to the following non-limiting example, which is illustrative only and not intended to limit the present disclosure to a particular embodiment.

### Example 1

In a first non-limiting example, a prism sight 10 as shown in any of FIGS. 1-4, may be described as provided in the following three paragraphs.

A fixed magnification optical aiming device for a firearm, comprising: (1) a prism system including a reticle, (2) one or more high efficiency illumination sources operationally configured to illuminate the reticle, (3) an MCU operationally configured to power the one or more high efficiency illumination sources, (4) one or more internal power supplies in electrical communication with the micro control unit, (5) one or more external power supplies in electrical communication with the micro control unit, (6) one or more solar cells in electrical communication with the micro control unit, and (7) a motion sensor in electrical communication with the micro control unit. In one embodiment, the one or more high efficiency illumination sources comprise one or more high efficiency LEDs. In one embodiment, the one or more high efficiency LEDs comprise one or more RCLEDs. In one embodiment, the MCU is operationally configured to draw a minimum of 9.0 nanoamps from the one or more external power supplies during operation of the fixed magnification optical aiming device. In one embodiment, the one or more internal power supplies comprise an internal storage capacity of 50.0 Amp-hours operationally configured to power the one or more RCLEDs at maximum brightness for a period up to 48.0 hours. In one embodiment, the prism system comprises a glass roof prism, a mirror prism and an intermediate lens disposed between the glass roof prism and mirror prism, the intermediate lens comprising a reticle. In one embodiment, the one or more solar cells comprise one or more flexible thin-film photovoltaic solar cells.

A prism sight for a firearm, comprising (1) a MCU mounted to a PCB, (2) a wake-up system mounted to the PCB in electrical communication with the MCU; (3) one or more internal power supplies in electrical communication with the MCU; (4) one or more external power supplies in electrical communication with the MCU; (5) one or more solar cells in electrical communication with the MCU; and (6) one or more high efficiency LEDs in electrical communication with the MCU; wherein the MCU is programmed to (a) turn the prism sight to an OFF position if no motion of the prism sight is detected for a predetermined period of time and (b) turn the prism sight to an ON position when the wake-up system detects motion of the prism sight; and wherein the one or more internal power supplies and one or more external power supplies are operationally configured to power the prism sight for a period of about one month when the prism sight is set to an ON position at a maximum brightness and in constant motion.

A fixed magnification optical aiming device for a firearm, comprising (1) a prism system including a reticle, (2) a primary internal power supply, (3) a secondary power supply operationally configured to recharge the primary power supply, and (4) a tertiary power supply comprising solar energy harvesting technology operationally configured to power the fixed magnification optical aiming device and charge the primary internal power supply.

Although the prism sight 10 is described above in terms of various exemplary embodiments and implementations, it should be understood that the various features and functionality described in one or more of the individual embodiments are not limited in their applicability to the particular embodiment with which they are described, but instead might be applied, alone or in various combinations, to one or more other embodiments whether or not such embodiments are described and whether or not such features are presented as being a part of a described embodiment. Thus, the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like.

Persons of ordinary skill in the art will recognize that many modifications may be made to the present disclosure without departing from the spirit and scope of the disclosure. The embodiment(s) described herein are meant to be illustrative only and should not be taken as limiting the invention, which is defined in the claims.

We claim:

1. A fixed magnification optical aiming device for a firearm, comprising:
a prism system including a reticle;
one or more high efficiency illumination sources operationally configured to illuminate the reticle;
an MCU operationally configured to power the one or more high efficiency illumination sources;
one or more internal power supplies in electrical communication with the MCU;
one or more external power supplies in electrical communication with the MCU;
one or more solar cells in electrical communication with the MCU; and
a motion sensor in electrical communication with the MCU.

2. The fixed magnification optical aiming device of claim 1 wherein the one or more high efficiency illumination sources comprise one or more high efficiency LEDs.

3. The fixed magnification optical aiming device of claim 1 wherein the one or more high efficiency LEDs comprise one or more RCLEDs.

4. The fixed magnification optical aiming device of claim 3 wherein the MCU is operationally configured to draw a minimum of 9.0 nanoamps from the one or more external power supplies during operation of the fixed magnification optical aiming device.

5. The fixed magnification optical aiming device of claim 4 wherein the one or more internal power supplies comprise an internal storage capacity of 50.0 Amp-hours operationally configured to power the one or more RCLEDs at maximum brightness for a period up to 48.0 hours.

6. The fixed magnification optical aiming device of claim 1 wherein the prism system comprises a glass roof prism, a mirror prism and an intermediate lens disposed between the glass roof prism and mirror prism, the intermediate lens comprising a reticle.

7. The fixed magnification optical aiming device of claim 1 wherein the one or more solar cells comprise one or more flexible thin-film photovoltaic solar cells.

8. A prism sight for a firearm, comprising:
a MCU mounted to a PCB;
a wake-up system mounted to the PCB in electrical communication with the MCU;
one or more internal power supplies in electrical communication with the MCU;
one or more external power supplies in electrical communication with the MCU;
one or more solar cells in electrical communication with the MCU; and
one or more high efficiency LEDs in electrical communication with the MCU;
wherein the MCU is programmed to (1) turn the prism sight to an OFF position if no motion of the prism sight is detected for a predetermined period of time and (2) turn the prism sight to an ON position when the wake-up system detects motion of the prism sight; and
wherein the one or more internal power supplies and one or more external power supplies are operationally configured to power the prism sight for a period of about one month when the prism sight is set to an ON position at a maximum brightness and in constant motion.
